(19) United States
(12) Patent Application Publication
(10) Pub. No.: US 2026/0172699 A1
(43) Pub. Date: Jun. 18, 2026

(54) IMPROVED WHITE BALANCE

(71) Applicant: STICHTING HET NEDERLANDS KANKER INSTITUUT - ANTONI VAN LEEUWENHOEK ZIEKENHUIS, Amsterdam (NL)

(72) Inventors: Henricus Josephus Cornelus Maria STERENBORG, Amsterdam (NL); Theodoor Jacques Marie RUERS, Amsterdam (NL)

(73) Assignee: STICHTING HET NEDERLANDS KANKER INSTITUUT - ANTONI VAN LEEUWENHOEK ZIEKENHUIS, Amsterdam (NL)

(21) Appl. No.: 19/124,297

(22) PCT Filed: Oct. 18, 2023
(86) PCT No.: PCT/EP2023/079036

§ 371 Date: Apr. 25, 2025

(30) Foreign Application Priority Data
Oct. 28, 2022 (NL) 2033415

(51) Int. Cl. H04N 23/88; H04N 23/71; H04N 23/76

(52) U.S. Cl. CPC H04N 23/88; H04N 23/71; H04N 23/76

(57) ABSTRACT

An image processing method comprises dividing (605) a plurality of pixels of an image into a first subset of pixels and a second subset of pixels. The image intensity of each pixel in the first subset is decomposing (606) using a variance of an image intensity of the pixels in a local neighbourhood of each pixel, to obtain at least one image property of each pixel in the first subset. Said at least one image property is spatially interpolated (607) to obtain said at least one image property in respect of at least one pixel in the second subset of pixels. The method further comprises decomposing (608) the image intensity of said at least one pixel in the second subset of pixels using the interpolated at least one image property of said at least one pixel in the second subset of pixels.

### FIELD OF THE INVENTION

The invention relates to an image processing method. The invention further relates to an image processing system. The invention further relates to a computer program product.

### BACKGROUND OF THE INVENTION

Imaging a sample optically generally involves a light source and a camera. The light source illuminates the sample and the camera images the light reflected from the sample. Optical imaging can be performed using a variety of light sources, lasers, light emitting diodes, incandescent lamps, or by ambient light. Colour imaging can then be performed with a regular colour camera having separate channels for red, green and blue. Spectral imaging can be performed with multispectral or hyperspectral cameras, recording images at a much larger number of wavelength bands.

Alternatively, optical imaging can be performed using a camera with a broadband sensitivity. RGB, multispectral or hyperspectral imaging can then be performed using scanning or switching light sources, generating light of different colours and wavelengths sequentially.

In optical imaging, the spectra or, in case of RGB imaging, the colour, of the detected image depends on, among others, the spectral shape of the illuminating light, the reflection spectrum of the sample, and the spectral sensitivity of the different colour or wavelength sensors in the camera.

To objectively determine a colour image or a spectral image, one can compensate for the spectral dependence of setup-related components, such as the incident light and camera, also known as performing a white balance. For this it is common practice to perform an additional measurement on a reference material. Such a reference measurement can be performed on a reference sample of which the reflection spectrum is known. The reflection of the sample can then be calculated from:

$${R}_{sample} ( λ ) = \frac{{I}_{sample} ( λ )}{{I}_{referene} ( λ )} {R}_{reference} ( λ )$$

wherein:
Rₛₐₘₚₗₑ(λ) stands for the reflection of the sample,
R_{reference}(λ) stands for the reflection of the reference material, which may be assumed to be known,
Iₛₐₘₚₗₑ(λ) stands for the intensities in the image obtained from the sample,
I_{reference}(λ) stands for the intensities in the image obtained from the reference material, which may be known from a reference measurement.

It is common practice in colour imaging to perform a white balance using a white tile as a reference material. In multispectral and hyperspectral imaging the reference measurement is often performed with a reflection standard, a material with a well-documented diffuse reflection spectrum, such as Spectralon, Spectralex, PFTE etc.

Imaging a sample optically can be performed using a light source and a camera. The light source illuminates the sample and the camera images the light reflected from the sample. Generally, there are two mechanisms that cause light incident on a sample to be reflected: Surface reflection and volume reflection. Surface reflection may refer to the phenomenon that, due to the difference in refractive index of the sample and the surrounding medium, a fraction of the incident light bounces off the interface between the sample and the medium around it. The fraction of the incident light that is not reflected at the surface of the sample may enter the sample. In diffusely scattering media, photons will scatter around until they are either absorbed, or leave the sample at some location. The part of the light that leaves the sample from the plane of incidence, after traveling through a part of the sample, is called the volume reflection.

Volume reflection consists of light that has been inside the sample and thus may give information on what is inside the tissue and is often the reason why we perform optical imaging. A camera usually cannot distinguish volume reflection from surface reflection and will detect the sum of the two. Surface reflection is usually not the primary target and can in some cases decrease the quality of the data collected.

After entering the sample, the transport of light is mainly governed by two processes: light scattering and light absorption. Light scattering alters the direction of the individual photons without changing any of its other properties. Light scattering is caused by local variations in the refractive index. Light absorption terminates a photon and transfers its energy to another form of energy. Light absorption takes place in electronic or vibrational absorption bands of the molecules in the tissue. It depends on the composition of the tissue and is highly wavelength dependent. Volume reflection is often the reason why we perform spectral imaging, because the spectral shape of the volume reflected radiation depends strongly on the absorbing components inside the tissue and thus provides information on what materials are inside the sample.

Light scattering in the sample causes light that has entered the sample to bounce around inside the sample in all directions. A part of the scattered light will be absorbed by molecular components of the sample, the rest of the scattered light will leave the sample at various locations. The part of this scattered light exiting at the plane of incidence is called volume reflected light, as this light does not have a single point of origin, but originates from a larger volume of the sample.

Surface reflection may be caused by the difference in refractive index of the sample and the surrounding medium. The fraction of the incident light that is reflected at the interface between the sample and medium from which it is imaged is described by Fresnel's equation. The surrounding medium may be, for example, air.

FIG. 1 shows an illustration of surface reflection on a flat surface, resembles reflection from a mirror: the angle of reflection ϑᵣ generally is equal to the angle of incidence ϑᵢ, defined with respect to a normal of the surface of the sample. A portion of the radiation may enter the sample at an angle of reflection ϑₜ.

When illuminating with a light source of limited size, the surface reflection only occurs in a very specific direction. In this case only a limited number of pixels in the camera receive the surface reflected light. Thus, often the surface reflected light is much stronger than the volume reflected light reaching the pixels. As a result, this type of surface reflection often leads to saturated pixels. It is common practice to avoid these reflections by choosing a different position of the camera, so that the surface reflected light misses the camera. As an alternative, it is not uncommon to use polarisation filters to suppress surface reflected light. This is based on the concept that the polarisation direction of the surface reflected light is parallel to the reflecting surface.

FIG. 2 illustrates surface reflection on a rough surface. This kind of surface reflection still resembles reflection from a mirror. However, the orientation of the mirror varies strongly with the position on the surface. Each spot on the surface where a light ray hits the surface will still function as a mirror and the angle of reflection is still equal to the angle of incidence. However, due to the strongly varying local orientation of the surface normal, the surface reflected light can be reflected in many different directions, as illustrated in FIG. 2. This phenomenon is known as ‘glare’. It can often be observed visually in reflection images as a whitish haze.

FIG. 3 illustrates volume reflection. The incident rays enter the sample, where they are subject to refraction. A portion of the refracted rays leave the tissue in any direction. The point where the refracted ray exits the tissue does not have to be the same as the point where the ray entered the tissue.

The occurrence of glare has the following consequences. The position of the camera can no longer be used to avoid detection of surface reflections, as the surface reflections are emitted in many directions. Many pixels will receive surface reflected light compared to the case of the flat surface. The surface reflection intensity, detected by these pixels, has a much lower intensity compared to the case of a flat surface, because the surface reflection is now spread over many different angles and thus over many pixels. Finally, the effectiveness of polarisation filters to avoid surface reflections is severely decreased, as the polarisation angle of the surface reflected light is as variable as the orientation of the surface.

In photography and image processing, white balance is the global adjustment of the intensities of the colors or wavelength intensities (typically red, green, and blue primary colors. In spectroscopy, any number of wavelength bands may be available). A goal of this adjustment is to render specific colors—particularly neutral colors such as white—correctly. Generalized versions of color balance are used to correct colors other than neutrals or to deliberately change them for effect. The term white balance is called that way due to the nature of the adjustment in which colors are adjusted to make a white object (such as a piece of paper or a wall) appear white and not bluish or reddish. In prior art, the white balance correction may be performed by acquiring a (white) reference sample to calibrate a correction model that may be applied to other images thereafter.

Image data acquired by sensors—either film or electronic image sensors—is generally transformed from the acquired values to new values that are appropriate for color reproduction or display. Several aspects of the acquisition and display process make such color correction essential—including that the acquisition sensors do not match the sensors in the human eye, that the properties of the display medium must be accounted for, and that the ambient viewing conditions of the acquisition differ from the display viewing conditions.

The above is provided for the purpose of providing an aid to understand the techniques disclosed herein. No statement is made as to what features would be known from the state of the art.

### SUMMARY OF THE INVENTION

There are several drawbacks to state of the art white balance correction. For example, the measurement for the white balance is performed at a different moment in time, prior to or after the imaging session. In the intervening time the spectral shape of the illuminating light may have changed. This is especially problematic when imaging with ambient light rather than a controlled light source. In addition, the white balance may be performed in a different source-sample-camera geometry than the imaging session. As a result, variations in the spatial distribution of the illuminating light may not be corrected correctly. In the case an artificial light source is used, the white balance may have to be repeated regularly because of changes in the spectral output of the source due to temporal instability or aging of the lamp. Likewise, variations in the reflecting properties of the reference tile will influence the calculated reflectance. The reference tiles used for white balance do not have the same physical shape as the sample to be imaged. As a result, there are difference in the source to sample and sample to detector distances. These differences may create sample dependent errors in the white balance. Surface reflections do not contain information from deeper inside the sample and its abundance may interfere with proper functioning of diagnostic algorithms. Completely removing surface reflections from an image has the downside that only the diffuse volume reflection remains. The volume reflection presents a blurry image and hampers proper focusing of the eye or the imaging optics.

It is an object of the invention to provide a method of performing a white balance for an image without performing a separate reference measurement.

It is another object of the invention to provide a method of performing a white balance for an image without the use of a distinct reference tile.

It is a further object of the invention to provide a method of performing a white balance for an image at the exact same time as the sample measurement, avoiding changes in the illuminating light between a time of acquiring an image of a reference tile and a time of acquiring an image of a measurement sample.

It is an additional object of the invention to provide a method of performing a white balance for an image while avoiding differences between a source-reference tile-camera geometry and a source-sample-camera geometry.

It is an additional object of the invention to reduce the glare in optical imaging.

It is yet a further object of the invention to produce a separate surface reflection image to enable proper focussing.

The following aspects aim to solve at least one of the problems mentioned above or implied by the present disclosure or address at least one of the objectives mentioned above or implied by the present disclosure.

According to a first aspect of the present invention an image processing method is provided, comprising
dividing a plurality of pixels of an image into a first subset of pixels and a second subset of pixels;
decomposing an image intensity of each pixel in the first subset using a variance of an image intensity of the pixels in a local neighbourhood of each pixel, to obtain at least one image property of each pixel in the first subset;
spatially interpolating said at least one image property to obtain said at least one image property of at least one pixel in the second subset of pixels;
decomposing the image intensity of said at least one pixel in the second subset of pixels using the interpolated at least one image property of said at least one pixel in the second subset of pixels.

Surprisingly, it is possible to decompose an image intensity and detect a relevant image property at pixels in a first subset of pixels, which may not be possible at other pixels of the image. The information about the image property can thereafter be interpolated to a remainder of the image, and used to decompose the image intensity of a pixel in the second subset. Thus, the image property may be extracted from the information contained within a portion of the image itself, without referring to a reference image or reference sample/tile. Herein the image intensity to be decomposed may be a scalar value, such as a real value.

At least one of said decomposing steps may comprise decomposing the image intensity into a portion caused by surface reflection with respect to a sample and a portion caused by volume reflection with respect to a sample. Such a decomposition surprisingly can be performed using the variance of some pixels, in particular the pixels in the first subset. Using the interpolated image property, such a decomposition may also be possible for the other pixels, in the second subset.

Surface reflection may comprise at least one of specular reflection and glare. On the other hand, volume reflection may comprise scatter inside the sample. The volume reflection thus may relate to photons that have penetrated into the sample and by scatter have exited the sample, so that they can be detected by a detector and contribute to the image intensity of the image's pixels.

The step of dividing the plurality of pixels may be performed based on an image intensity of the pixels. The image intensity can help to decide which pixels are suitable to be included in the first subset and the second subset.

The step of dividing the plurality of pixels may be performed based on a spatial variance of an image intensity of the pixels. The spatial variance also provides information to decide which pixels are suitable to be included in the first subset and the second subset.

The step of decomposing the image intensity of each pixel in the first subset may comprise decomposing that image intensity into at least one component associated with volume reflection, at least one component associated with surface reflection, and at least one further component; and wherein the image property is associated with the at least one further component. This decomposition greatly helps to distinguish volume reflection from surface reflection in other pixels (e.g. the pixels of the second subset).

The at least one component associated with surface reflection may comprise a component associated with a reflection parameter, for example a Fresnel reflection parameter, that depends on a wavelength, and a component associated with a coefficient that depends on a spatial location of each pixel. This provides a further decomposition of the surface reflection component. By decomposing the surface reflection component into a wavelength dependent parameter and a spatial dependent coefficient, it becomes possible to separate these dependencies, thus allowing to solve the equations involved in determining the surface reflection more easily.

The at least one component associated with volume reflection may comprise a component that depends on a wavelength. This helps to separate the influence of wavelength from the influence of spatial location as regards volume reflection.

The step of decomposing the image intensity of each pixel in the first subset may comprise solving an equation for the image property in respect of the plurality of different wavelength bands, the component associated with volume reflection in respect of the plurality of wavelength bands, the component associated with the reflection parameter in respect of the plurality of wavelength bands, and the component associated with the coefficient in respect of a plurality of pixels in a neighbourhood of each pixel, based on the pixel intensities in respect of the plurality of pixels in the neighbourhood of each pixel in respect of the plurality of different wavelength bands. Surprisingly, these decompositions may be made using just the image intensities of the pixels for the appropriate wavelength bands.

The step of decomposing the image intensity of said at least one pixel in the second subset of pixels may comprise decomposing the image intensity of said at least one pixel in the second subset of pixels into at least one component associated with volume reflection and at least one component associated with surface reflection, using the interpolated at least one image property of said at least one pixel in the second subset of pixels as an input. The knowledge of the interpolated at least one image property helps to decompose the image intensity in the second subset of pixels.

The step of decomposing the image intensity of said at least one pixel in the second subset of pixels may comprise solving an equation for the component associated with volume reflection in respect of the plurality of wavelength bands, the component associated with the reflection parameter in respect of the plurality of wavelength bands, and the component associated with the coefficient in respect of a plurality of pixels in a neighbourhood of said at least one pixel in the second subset of pixels, based on the pixel intensities of the plurality of pixels in the neighbourhood of said at least one pixel in the second subset of pixels in respect of the plurality of different wavelength bands and further based on the spatially interpolated image property in respect of said at least one pixel in the second subset of pixels and the plurality of different wavelength bands. The set of equations thus created surprisingly can be solved to provide the desired decomposition.

The image property may be associated with a reference intensity. This provides the advantages of having a reference intensity for e.g. white balance, without performing an actual reference measurement. For example, the image property may be associated with a calibration intensity, which may represent a combination of reference intensity and reference reflection.

The equations (for either or both of the first subset of pixels and the second subset of pixels) may be based on a multiplication of the image property and a combination of the component associated with volume reflection, the component associated with the reflection parameter, and the component associated with the coefficient. This way, the image property may be treated similar to the reference intensity, even though no reference measurement is needed.

The image processing method may further comprise generating an output image based on a weighted combination (for example, a weighted superposition or a nonlinear combination) of the decomposed image intensities. This may help to provide improved image. For example, the volume reflected component may be enhanced and the surface reflected component may be reduced, while still keeping enough of the surface reflected component to recognize the shape of surfaces shown in the image. Alternatively, the colour of the pixels or of the volume reflection component thereof may be corrected based on the image property. The method may allow to correct the image to remove any dependency on the light source; in particular, the dependency on the position of the light source and/or the colour of the illumination light may be reduced.

According to another aspect, an image processing system is provided, comprising
an input unit configured to obtain an input image comprising a plurality of pixels;
an output unit configured to output an output image based on a decomposed image intensity of at least one pixel of the input image; and
an image processing unit configured to:
divide the plurality of pixels of the input image into a first subset of pixels and a second subset of pixels;
decompose an image intensity of each pixel in the first subset using a variance of an image intensity of the pixels in a local neighbourhood of each pixel, to obtain at least one image property of each pixel in the first subset;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.

According to another aspect, a computer program is provided comprising instructions configured to cause, when executed by a processor system, the processor system to:
divide a plurality of pixels of an image into a first subset of pixels and a second subset of pixels;
decompose an image intensity of each pixel in the first subset using a variance of an image intensity of the pixels in a local neighbourhood of each pixel, to obtain at least one image property of each pixel in the first subset;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.

As a general advantage of the above described method and system, it is observed that there is no, or reduced, dependence on position of light sources, or of the spectra of the environmental light.

The person skilled in the art will understand that the features described above may be combined in any way deemed useful. Moreover, modifications and variations described in respect of the method may likewise be applied to the system and to the computer program product, and modifications and variations described in respect of the system may likewise be applied to the method and to the computer program product.

### BRIEF DESCRIPTION OF THE DRAWINGS

In the following, aspects of the invention will be elucidated by means of examples, with reference to the drawings. The drawings are diagrammatic and may not be drawn to scale. Throughout the drawings, similar items may be marked with the same reference numerals.

FIG. 1 illustrates a surface reflection on a flat surface.

FIG. 2 illustrates a surface reflection on a rough surface.

FIG. 3 illustrates a volume reflection.

FIG. 4 shows a graph illustrating normalised Fresnel reflection.

FIG. 5 shows a block diagram illustrating aspects of an imaging apparatus.

FIG. 6 shows a flowchart illustrating aspects of an image processing method.

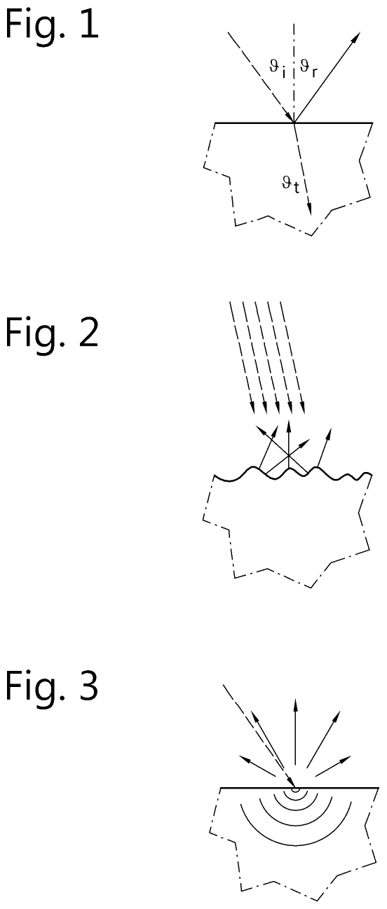

### DETAILED DESCRIPTION OF EMBODIMENTS

Certain exemplary embodiments will be described in greater detail, with reference to the accompanying drawings.

The matters disclosed in the description, such as detailed construction and elements, are provided to assist in a comprehensive understanding of the exemplary embodiments. Accordingly, it is apparent that the exemplary embodiments can be carried out without those specifically defined matters. Also, well-known operations or structures are not described in detail, since they would obscure the description with unnecessary detail.

FIG. 5 shows an exemplary imaging apparatus 500. The imaging apparatus 500 may comprise a light source 501 configured to illuminate a place for a sample 503. For example, the light source 501 may comprise a light emitting diode (LED), an incandescent light, or any other light generating device. In addition, the light source 501 may comprise optics to filter the light and/or to guide and/or bundle the light in a certain direction, in particular to a designated place for a sample 503. In certain embodiments the light source 501 may be omitted. Instead, the apparatus 500 may be dependent on environmental light or any kind of available natural or artificial light that illuminates the sample 503. The apparatus 500 may comprise a placeholder 504, such as a support, for the sample 503. However, in certain embodiments the placeholder 504 may be omitted as the sample 503 may be kept in place in any other way. Or the apparatus 500 may be used as a generic photo or video camera, for example.

The apparatus 500 may further comprise an input unit 503, such as a camera 503. The camera 503 may be any generic camera, e.g. RG B camera that captures red, green, and blue channels. In addition or alternatively, the camera may be configured to capture one or more bands in near infra-red (NIR), far infrared, and/or ultraviolet. For example, the camera 503 may comprise a multispectral detector. The camera 503 may comprise at least one photosensitive element, such as a chip. In certain embodiments, multiple photosensitive elements may be provided to acquire light intensity in multiple different wavelength bands. The camera may further comprise optical elements, such as one or more filters, light guides, and light splitters. Light splitters may be used, for example, to guide the light to the different photosensitive elements. In alternative embodiments, the input unit 503 may be replaced, for example, by a communication device that receives the image from another device via wired or wireless communication.

The apparatus 500 may comprise a storage media 507 for storing images captured by the camera 503. The storage media 507 may also be used to store any operating parameters, for example framerate, image resolution, wavelength bands to be recorded, focal spot, or any other settings of the camera 503. Operating parameters may also include settings of the light source 501, which may include light intensity, focal spot, etc. The apparatus 500 may further comprise an output device 506, such as a display device, e.g. a monitor, or a printer. Alternatively, the output device may comprise a communication device to transmit an output image to another device via wired or wireless communication.

The apparatus 500 comprises an image processing unit 508, which is configured to process the images acquired by the camera 503. The image processing unit 508 may be capable of several image enhancement or image analysis operations. In particular, the image processing unit can separate volume reflections from surface reflections. Moreover, the image processing unit may be capable of generating an improved image based on a combination of the separated volume reflection image and the separated surface reflection image. Further, the image processing unit 508 may be capable of performing a white balance even without calibrating with a reference sample. Also, the image processing unit 508 may be capable to detect image regions containing surface reflections.

The apparatus 500 may further comprise a control unit 505. The control unit 505 may be configured to control operation of the apparatus, which may comprise operation of one or more of the light source 501, the camera 503, the storage media 507, the display 506, and the image processing unit 508. In certain embodiments, the control unit 505 and the image processing unit 508 may be integrated on the same piece of hardware. The hardware of the control unit may comprise one or more computer processors, central processing units, and/or graphical processing units. The control unit 505 and/or the image processing unit 508 may comprise a computer program stored on a non-tangible storage media with instructions to cause the control unit 505 and/or the image processing unit 508 to perform its functions. The control unit 505 may alternatively be implemented in the form of a dedicated electronic circuit. The same hardware implementations are possible for the image processing unit 508.

The image processing unit 508 may be configured to, under control of the control unit 505, receive image data from the camera 503, process the images, and store processed images and data to the storage media 507. Further, the image processing unit 508 may be configured to output images to the output device 506. In practical implementations more components may be involved in the image pipeline from camera 503 to output device 506 and/or storage media 507. These additional components and details have been omitted in the present disclosure in order not to obscure the details of the invention.

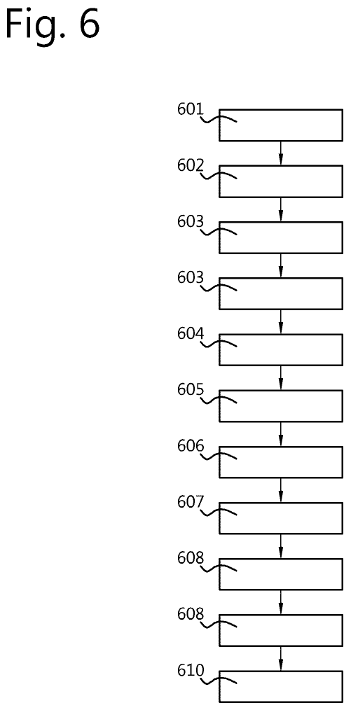

FIG. 6 shows a flowchart of a method, to be performed with the image processing apparatus 500, for example under control of the control unit 505.

In step 601, the apparatus (in particular the light source 501 and/or the camera 503) is positioned with respect to a sample 503. For example, the camera 503 and light source 501 are positioned and/or a sample is put in a designated position, e.g. on a support 504. This step 601 is to be regarded as an optional preparatory step. The method may be performed on any image acquired by the camera, whether a particular sample is provided or not.

In step 602, the sample 502 may be illuminated by the light source 501. This step may be performed manually or under control of the control unit 505.

In step 603, the camera 503 may capture an image of the sample 503, optionally while the sample 503 is illuminated by the light source 501. The image may contain a plurality of pixels. E ach pixel may contain intensities in respect of a plurality of different wavelength bands.

In step 604, the image processing unit 508 receives the captured image that was captured by the camera 503. In certain embodiments, the image may be transmitted from the camera 503 to the storage media 507, and thereafter from the storage media 507 to the image processing unit 508.

In step 605, the image processing unit performs an analysis of the image to detect a first subset of pixels and a second subset of pixels. For example, the first subset of pixels may be detected based on a spatial variance of intensities around each pixel. For example, pixels having a relatively high spatial variance of intensities may be included in the first subset of pixels. This spatial variance may be calculated using a group of pixels around the pixel, for example all 8 or 24 pixels in a square around the pixel. The spatial variance may be calculated for each wavelength band separately, and then averaged over the wavelength bands. Alternatively, the spatial variance may be calculated for just one wavelength band or a group of wavelength bands that is/are considered to be representative for the general variance.

Further, pixels that show clipping, e.g. pixels with very large intensities above a threshold, may be excluded from the first subset of pixels. These clipped pixels usually also have a small spatial variance.

In certain embodiments, the first subset of pixels contains all the pixels of the image that satisfy certain predetermined conditions on the variance and/or intensity. For example certain threshold values. Alternatively, the first subset only contains a representative number of the pixels that satisfy the conditions. Preferably, to allow good interpolation, the pixels in the first subset of pixels are distributed over the entire image.

The pixels of the image that are not included in the first subset, may be included in the second subset. In certain embodiments, all the pixels of the image are included in either one of the first subset or the second subset. However, this is not a limitation. Some pixels may be left out and not included in either subset.

In step 606, the pixels in the first subset are analysed. For example, the image intensities of a pixel in the first subset may be decomposed into a plurality of components, based on a variance of an image intensity of the pixels in a local neighbourhood of the pixel. One of the components may be an image property of the pixel. This decomposition may be performed for each of the available wavelength bands. For example, a set of equations is generated, one equation for every combination of pixel (location x,y) and wavelength λ. Only the pixels in a neighbourhood around a specific pixel x₀,y₀ in the first subset are included in the set of equations. For every specific pixel to be decomposed, a separate set of equations may be generated and solved using the pixels around each specific pixel. The equations may contain the components as unknown variables. These unknown variables may be set to depend on either the wavelength band or on the pixel (location), or both. Also, the equations may define a relationship between the components in terms of addition, subtraction, multiplication, and/or division. This relationship may be a linear combination or, advantageously, a non-linear combination. This set of equations may be numerically solved, for example. One of the components may be the at least one image property. This image property may define a calibration intensity X_{ref}(x₀,y₀,λ), for example. Thus, every wavelength band may have its own at least one image property. The other components, represented in the equations, may include a volume refraction coefficient Rᵥₒₗ(x₀,y₀,λ), a position-dependent surface reflection coefficient β(xᵢ,yᵢ), and a wavelength-dependent surface reflection coefficient

$${r}_{fresnel} ( \frac{λ}{589 nm} ) .$$

In certain embodiments, when performing this decomposition for a specific pixel x₀,y₀ in the first subset, the image property may be set independent of spatial location, the volume refraction coefficient may be set independent of spatial location, the position-dependent surface reflection coefficient may be set independent of wavelength, and the wavelength-dependent surface reflection coefficient may be set independent of spatial location.

In step 607, the at least one image property, that was calculated for the pixels of the first subset of pixels, may be interpolated spatially, in order to obtain a value of the at least one image property for each of the pixels in the second subset of pixels. For example, bilinear interpolation may be applied, or polynomial interpolation. Any suitable interpolation method may be used. The wavelength-dependent image property, such as the calibration intensity X_{ref}(x₀,y₀,λ), may be spatially interpolated for each wavelength band separately.

In step 608, the image intensity of each pixel of the second subset of pixels may be decomposed. In this decomposition of the second subset of pixels, the interpolated at least one image property is considered as a known value. Hence, only the remaining components are determined in step 608. These remaining components may include, for example, a volume refraction coefficient Rᵥₒₗ(x₀,y₀,λ), a position-dependent surface reflection coefficient β(xᵢ,yᵢ), and a wavelength-dependent surface reflection coefficient

$${r}_{fresnel} ( \frac{λ}{589 nm} ) .$$

Similar to step 606, the decomposition of step 608 may be performed for each of the available wavelength bands. For example, a set of equations is generated, one equation for every combination of pixel (location x,y), in a local neighbourhood around a pixel x₀,y₀, and wavelength λ. The equations may contain the components as unknown variables. These unknown variables may be set to depend on either the wavelength band or on the pixel (location), or both. Also, the equations may define a relationship between the components in terms of operations such as addition, subtraction, multiplication, and/or division. This relationship may be a linear combination or, advantageously, a non-linear combination. This set of equations may be numerically solved, for example, to extract at least one image property.

In certain embodiments, when performing this decomposition for a specific pixel x₀,y₀ in the second subset, the volume refraction coefficient may be set independent of spatial location, the position-dependent surface reflection coefficient may be set independent of wavelength, and the wavelength-dependent surface reflection coefficient may be set independent of spatial location. Optionally the image property may be set independent of spatial location.

In step 609, an output image is generated based on the decomposed pixel values. This may be performed in several ways. For example, a colour correction may be performed based on the image property. For example, a colour corrected image may be generated by the output consisting of the appropriate mix of volume and surface reflection as generated by the procedure. Alternatively, the amount of surface reflection versus volume reflection may be adjusted by multiplying each component with a certain factor. This way, for example, volume reflection may be reduced compared to volume reflection. These and other image enhancement procedures are known from the field of white balance corrections in photography and optical microscopy.

Alternatively, one may output the volume reflection only. This would represent information on the sample optical properties and can be used for visual guidance or for diagnostic algorithms.

Alternatively, one may output the surface reflection only. This would represent information on the surface structure and can be used for visual guidance or for diagnostic algorithms.

Alternatively one may output both the volume reflection and the surface reflection and can simultaneously be used for visual guidance or for diagnostic algorithms.

In step 610, the output image is outputted, for example by displaying it on a display device, transmitting it to another device by a communication device using wired or wireless communication, and/or storing it on a storage media.

We define a colour image or a hyperspectral image as a 3 dimensional matrix, or data cube of intensities, I(x,y,λ), where x and y are the spatial indices of the pixels, and λ is the wavelength index. The wavelength index λ can run from 1 to n_{λ}, with n_{λ} a positive integer. An image of which the pixels have red, green, and blue wavelength bands may be referred to as an RGB image. For an RGB image n_{λ}=3, whereas for multispectral or hyperspectral image n_{λ} can be much larger.

We already introduced the concept that the reflected intensity imaged from a sample may consist of volume reflection and surface reflection:

$${I}_{sample} ( x , y , λ ) = {I}_{vol} ( x , y , λ ) + {I}_{surf} ( x , y , λ ) . \qquad Equation 1$$

We define the volume reflection coefficient, Rᵥₒₗ, and surface reflection coefficient, R_{surf} as:

$${R}_{vol} ( x , y , λ ) = \frac{{I}_{vol} ( x , y , λ )}{{I}_{ref} ( x , y , λ )} \qquad Equation 2$$

$${R}_{surf} ( x , y , λ ) = \frac{{I}_{surf} ( x , y , λ )}{{I}_{ref} ( x , y , λ )} .$$

Where I_{ref}(x,y,λ) stands for a perfect reference spectrum, which may be defined as the reflected intensity of a reference sample whose reflection coefficient R_{ref}(λ) is equal to 1 for all λ.

The inventor has observed that the volume reflection changes only slowly with x and y, while the surface reflection can be different for each pixel (x,y). This means that for a group of closely adjacent pixels, we can write:

$${R}_{v o l} ( x , y , λ ) = \frac{{I}_{v o l} ( {x}_{0} , {y}_{0} , λ )}{{I}_{r e f} ( x , y , λ )} \qquad Equation 3$$

$${R}_{surf} ( x , y , λ ) = \frac{{I}_{surf} ( x , y , λ )}{{I}_{ref} ( x , y , λ )} ,$$

with x,y close to x₀,y₀.

The observation that the volume reflection changes only slowly with x and y, while the surface reflection can be different for each pixel (x,y) is not a universal truth, but holds for most practical cases: For instance for biological samples the optical diffusion length, i.e. the optical blurring dimension, may vary between e.g. 1 and 10 mm. The sizes of surface roughness, (i.e. wrinkles, dents etc.) are typically below 1 mm.

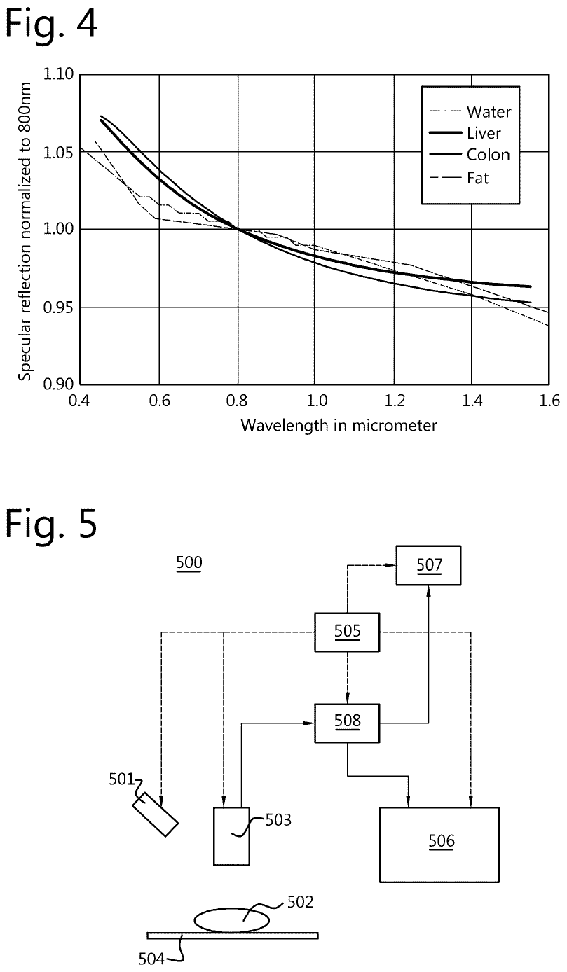

FIG. 4 shows a graph illustrating the relationship between the wavelength (horizontal axis shows wavelength divided by 589 nm) and normalized Fresnel reflection coefficient (vertical axis) of water, human fat, and colon. Another observation made by the inventor is that in the wavelength range commonly used for optical imaging, the Fresnel reflection varies very little with wavelength. In addition, the variation with wavelength observed is similar for many biological materials. In addition, we have observed that in most mammalian tissues it lies between the two extremes of water and fat. As a result, we can write:

$${R}_{fresnel} ( x , y , λ ) = {R}_{fresnel} ( x , y , 589 nm ) {r}_{fresnel} ( \frac{λ}{589 nm} ) , \qquad Equation 4$$

$$wherein {r}_{fresnel} ( \frac{λ}{589 nm} )$$

is a normalized Fresnel reflection coefficient, examples of which are shown in FIG. 4 (for example an average of several representative tissue types may be used, for example an average of the values for water and a representative fat). So now we have expressed the Fresnel reflection spectrum in each pixel as a spatially dependent amplitude multiplied by a spectral shape that is identical throughout the image.

Thus, the wavelength dependence of the Fresnel reflection does no longer depend on x and y. Defining the glare or surface reflection as a fraction of the local specular reflection, we can turn Equation 4 into:

$${R}_{surf} ( x , y , λ ) = β ( x , y ) {r}_{fresnel} ( \frac{λ}{589 nm} ) , \qquad Equation 5$$

wherein β(x,y)=α(x,y)R_{fresnel}(x,y,589 nm). Herein, α(x,y) is a pixel dependent factor (varying from 0 to 1) that accounts for the strength of the glare in that pixel and R_{fresnel}(x,y,589 nm) denotes the Fresnel reflection coefficient at a reference wavelength of 589 nm, based on the refractive indices of the sample and of air at this wavelength, and

$${r}_{fresnel} ( \frac{λ}{589 nm} )$$

denotes the Fresnel reflection normalized to unity at the reference wavelength. Herein, and throughout the present disclosure, in alternative implementations the wavelength 589 nm may be replaced by any other appropriate value as desired.

Now consider a subset of the image consisting of m pixels: the pixel located at x₀, y₀ and m−1 pixels located at xᵢ, yᵢ, for i=1, 2, . . . , m−1, within close proximity to the pixel located at x₀, y₀:

$${I}_{sample} ( {x}_{i} , {y}_{i} , λ ) = {I}_{v o l} ( {x}_{i} , {y}_{i} , λ ) + {I}_{surf} ( {x}_{i} , {y}_{i} , λ ) {\vert}_{i = 0}^{m - 1} . \qquad E quation 6$$

In the above equation, for convenience we defined that x₀,y₀=xᵢ,yᵢ, for i=0. Now, combining with equations 3 and 5 yields:

$${I}_{sample} ( {x}_{i} , {y}_{i} , λ ) = {X}_{ref} ( {x}_{i} , {y}_{i} , λ ) \{ {R}_{v o l} ( {x}_{0} , {y}_{0} , λ ) + β ( {x}_{i} , {y}_{i} ) {r}_{fresnel} ( \frac{λ}{589 nm} ) \} {\vert}_{i = 0}^{m - 1} . \qquad Equation 7$$

The parameter X in the above equation may be called the calibration spectrum and is defined as

$${X}_{ref} ( {x}_{i} , {y}_{i} , λ ) = \frac{{I}_{ref} ( {x}_{i} , {y}_{i} , λ )}{{R}_{ref} ( λ )}$$

Assuming that X_{ref} varies in space, but like Iᵥₒₗ, not too steeply over the pixels, we can write:

$${X}_{ref} ( {x}_{i} , {y}_{i} , λ ) = {X}_{ref} ( {x}_{0} , {y}_{0} , λ ) {\vert}_{i = 0}^{m - 1} . \qquad Equation 8$$

Which combined with Equation 7, leads to:

$${I}_{sample} ( {x}_{i} , {y}_{i} , λ ) = {X}_{ref} ( {x}_{0} , {y}_{0} , λ ) \{ {R}_{v o l} ( {x}_{0} , {y}_{0} , λ ) + β ( {x}_{i} , {y}_{i} ) {r}_{fresnel} ( \frac{λ}{589 nm} ) \} {\vert}_{i = 0}^{m - 1} . \qquad Equation 9$$

What we have now for the group of m pixels centered in and around x₀,y₀, is a total of m·n_{λ} equations with 3 n_{λ}+m unknowns (i.e. the 3 spectra: X_{ref}, Rᵥₒₗ and r_{fresnel} and a surface reflection intensity value β for each pixel). Herein, X_{ref} may be any positive number, Rᵥₒₗ may have a value in a range from 0 to 1, β(xᵢ,yᵢ) may be in a range of 0 to 1 and r_{fresnel} may be any positive number.
Equation 9 can be solved if the following condition is fulfilled:

$$m \cdot {n}_{λ} > 3 {n}_{λ} + m . \qquad Equation 10$$

In practice, there is an inaccuracy, e.g. electronic noise, added to the measured intensity.

$${I}_{sample} ( {x}_{i} , {y}_{i} , λ ) = {X}_{ref} ( {x}_{0} , {y}_{0} , λ ) \{ {R}_{v o l} ( {x}_{0} , {y}_{0} , λ ) + β ( {x}_{i} , {y}_{i} ) {r}_{fresnel} ( \frac{λ}{589 nm} ) \} + σ ( {x}_{i} , {y}_{i} , λ ) {\vert}_{i = 0}^{m - 1} , \qquad Equation 11$$

wherein σ(xᵢ,yᵢ,λ) is the noise. As the noise may be different for each observation, there may be a different noise value for each pixel and each wavelength band.
We can solve Equation 11 for instance by minimising the sum of squares Q:

$$Q = {\sum }_{i = 0}^{m - 1} {( \frac{\begin{matrix}{I}_{s a m p l e} ( {x}_{i} , {y}_{i} , λ ) - {X}_{ref} ( {x}_{0} , {y}_{0} , λ ) \\ \{ {R}_{v o l} ( {x}_{0} , {y}_{0} , λ ) + β ( {x}_{i} , {y}_{i} ) {r}_{fresnel} ( \frac{λ}{589 nm} ) \}\end{matrix}}{w ( {x}_{i} , {y}_{i} , λ )} )}^{2} , \qquad Equation 12$$

wherein w(xᵢ,yᵢ,λ) is an optional weighing factor. Such a weighing factor may be useful when the individual values of Iₛₐₘₚₗₑ(xᵢ,yᵢ,λ) vary strongly within one subset. When the noise is very wavelength dependent, it may be suitable to use w(xᵢ,yᵢ,λ)=σ(xᵢ,yᵢ,λ) (wherein σ denotes the standard deviation) so that the noisier pixels contribute less. One can choose w(xᵢ,yᵢ,λ)=1 when weighing is not desired.

By minimising Q from Equation 12, we obtain a value for Rᵥₒₗ. We eliminated the necessity of a separate reference measurement. Also a reference tile is not needed to determine Rᵥₒₗ. Using the techniques disclosed above, a white balance of an image can be performed using just the information that is present in the image. Therefore also there are no problems with changes in the illuminating light that might occur between a time of acquiring an image of a reference tile and a time of acquiring an image of a measurement sample.

We can continually update the values of the quantities of X_{ref}(x₀,y₀,λ), Rᵥₒₗ(x₀,y₀,λ)+, β(xᵢ,yᵢ), and

$${r}_{fresnel} ( \frac{λ}{589 nm} )$$

based of the contents of an image (that is, Iₛₐₘₚₗₑ(xᵢ,yᵢ,λ)). The information used to eliminate the unknowns may be obtained from pixels xᵢ,yᵢ corresponding to an area close to the imaged pixel x₀,y₀, so the correct source-sample-camera geometry is applicable. Finally, the volume reflection is separated from the surface reflection, so that we can reduce glare by reducing the surface reflection component or produce a separate surface reflection image.

For a regular colour image with n_{λ}=3, Equation 9 can be solved if at least 5 pixels are compared, so for instance the central pixels and 4 neighbours.

For multispectral and hyperspectral images, the use of at least 3 neighbours is sufficient.

In case one would consider r_{fresnel} to be known, then n_{λ} unknowns disappear from the equation and Equation 10 turns into:

$$m \cdot {n}_{λ} > 2 {n}_{λ} + m . \qquad Equation 13$$

As a consequence, even less neighbouring pixels would be needed to be able to solve equation 9. In all cases, more pixels may be involved, for example to reduce the effect of noise.

The decision which pixels xᵢ,yᵢ to use in the calculations may depend on the type of camera that is used. Preferably these pixels are close to each other spatially. Preferably only pixels are selected that are acquired at the same time. For example, for a regular RGB camera or a multispectral snapshot camera, where the entire data cube is acquired simultaneously, neighbours in both the x and the y direction can be chosen. On the other hand, a pushbroom camera acquires lines of spectra in one spatial direction and accumulates a data cube by physically scanning a sample in the other spatial direction. In such a case, pixels are preferably selected only in the spatial direction that are acquired simultaneously, i.e. along the direction of the broom, and preferably not in the direction in which it is pushed.

The decision how many pixels xᵢ,yᵢ to use in the calculations is a bit more complicated as suggested by Equations 10 and 13.

The numbers generated by the camera's may be digital, they have a limited resolution, typically 8-16 bit. In addition, there may be noise added to these numbers, this noise may be stronger for some wavelengths than for others and will increase for lower count rates. Therefore it is preferable to use a larger number of pixels than given in Equations 10 and 13.

The process of least squares minimisation of Equation 12 is a classical mathematical problem for which many algorithms have been developed. The general experience is that these algorithms take more time with increasing number of variables. In addition, because of the noise there may be many local minima that may satisfy the algorithm's stop criteria, but do not represent the actual minimum of Q and therefore do not yield the proper values for Rᵥₒₗ, X_{ref}, β and r_{fresnel}.

The number of variables can be particularly high in hyperspectral cameras, where often many more than 100 wavelength channels are available in the camera. The value of n_{λ} is typically more than 2000 for silicon based cameras and more than 350 for InGaAs based cameras.

The number of physical parameters determining the shape and intensity of a volume reflection spectrum may be estimated to be usually in the order of 10, maximally 20. As a result, current hyperspectral cameras may grossly oversample these spectra. As a consequence the computation time for minimising Equation 12 may be much higher than needed for a reliable solution. A significant reduction in the number of parameters can be reached by using a mathematical function of a set of parameters to describe Rᵥₒₗ. This could be either a purely descriptive function without any physical background, such as a polynomial, or a Fourier series. Alternatively, one could use a model-based function, such as the one derived from the radiation transfer equation published by Welch and Van Gemert. Thirdly, one could use an empirical function, based on observations of possible shapes of the diffuse reflection spectrum as in Kanick et al., Method to quantitate absorption coefficients from single fiber reflectance spectra without knowledge of the scattering properties, Opt. Lett. 2011 vol. 36, 2791-2793.

Likewise, in many cases the Fresnel reflection spectrum can be modelled quite accurately with a first or second order polynomial (as may be appreciated from FIG. 4).

In addition, the calibration spectrum X_{ref} in all its possible shapes can be described mathematically with sufficient accuracy, using much less variables than n_{λ}. So, parametrising the 3 output spectra involved may significantly increase the speed and accuracy of the minimisation of Q in Equation 12.

One important note to minimising Q in Equation 12 is that it assumes that a sufficient number of the m·n_{λ} different equations are independent. So Equation 10 may be redefined as a condition that at least 3 n_{λ}+m equations are independent.

The independence of the equations may be influenced by circumstances of the measurement. For example, for independence of the equations it helps if the shape of the volume reflection spectrum Rᵥₒₗ(x₀,y₀,λ) and the Fresnel reflection r_{fresnel}(λ) are sufficiently different in shape. The inventors have observed that volume reflection spectra are highly wavelength dependent and display many absorber-specific dips in the spectra, while the Fresnel spectra from tissue (and the underlying spectra of the refractive index) are very smooth with wavelength. Thus, this condition is met in many practical circumstances, including optical measurement of biological material, including human tissue.

Further, for independence of the equations it helps if there is sufficient amount and variability in the surface reflection: β(xᵢ,yᵢ). The inventors have observed that this may not always be the case. Such a lack of surface reflection intensity or spatial variation in intensity, combined with the instrument noise present in Iₛₐₘₚₗₑ, may cause a badly defined minimum in Q of Equation 12, and may result in large errors or uncertainties in the resulting values for Rᵥₒₗ, X_{ref} and β. The inventors have observed that this can occur frequently. In the following, an approach is presented to overcome this problem.

To this end we introduce a parameter G as a relative measure of how much pixel-to-pixel variation exists locally around x₀,y₀:

$$G ( {x}_{0} , {y}_{0} ) = \frac{stdev ( {\int }_{{λ}_{1}}^{{λ}_{2}} {I}_{sample} ( {x}_{i} , {y}_{i} , λ ) d λ [ i = 0 … m - 1 ] )}{mean ( {\int }_{{λ}_{1}}^{{λ}_{2}} {I}_{sample} ( {x}_{i} , {y}_{i} , λ ) d λ [ i = 0 … m - 1 ] )} , \qquad Equation 14$$

where G(x₀,y₀) is in fact the relative variability in the total intensity around x₀, y₀ and λ₁ and λ₂ are integration boundaries for determining the total output of a pixel. One can consider the entire output spectrum, or only a relevant part of it. The integration may be replaced by a summation of intensities of the available wavelength bands. The inventors named the parameter G the ‘Glarity’ factor, because it is indicative of image areas containing glare.

An exemplary approach to applying the invention to an acquired image may comprise the following steps:
Step 1: Calculate the Glarity matrix, G, for all pixels in the image. Alternatively, the Glarity parameter may be calculated for a large number of pixels of the image.
Step 2: Determine for which pixels xₐ,yₐ the value of G is larger than a predetermined threshold value G_{threshold}. Herein, a is an index of those pixels.
Step 3: For the pixels xₐ,yₐ with G(xₐ,yₐ)≥G_{threshold}, determine Rᵥₒₗ(xₐ,yₐ,λ), X_{ref}(xₐ,yₐ,λ), r_{fresnel}(λ), and β(xₐ,yₐ) by minimising Q from Equation 12.
Step 4: Now, for the pixels x_{b},y_{b} with a G<G_{threshold}, calculate the values for X_{ref}(x_{b},y_{b},λ) by interpolation between the points xₐ,yₐ in the neighbourhood calculated under step 3. Herein, b is an index of the pixels that are smaller than the threshold.
Step 5: now substitute the interpolated values of X_{ref}(x_{b},y_{b},λ) into Equation 12 and determine Rᵥₒₗ(x_{b},y_{b},λ), r_{fresnel}(λ), and β(x_{b},y_{b}) by minimising Q. Again, if r_{fresnel}(λ) is known, its value may also be substituted before minimizing Q.

The above approach may lead to a reduction of the number of variables in areas of the image where there is little pixel-to-pixel variation in glare. This way, the number of independent equations needed to solve the set of equations is likewise reduced. What we have after substituting X_{ref}(x_{b},y_{b},λ) is a total of m·n_{λ} equations with 2n_{λ}+m unknowns (i.e. the 2 spectra: Rᵥₒₗ and r_{fresnel} and a surface reflection intensity value β for each pixel). If r_{fresnel} is also known, we have only n_{λ}+m unknowns (i.e. the spectrum: Rᵥₒₗ and a surface reflection intensity value β for each pixel), the number of equations remaining the same.

Spectral imaging for crop and harvest monitoring and monitoring of the health status of natural foliage usually encompasses large areas outdoors. In these applications, the illumination is often based on ambient light. The spectral properties of the ambient light may change rapidly during the day and will strongly depend on the season. In addition, especially when imaging large areas, the spectral distribution as well as the intensity of the illuminating light will vary over the imaged range. Especially in the case where such images would be taken from drones, airplanes or satellites it would be very cumbersome to place reference tiles over the entire imaged region and perform classical reference measurements. For example a method may comprise obtaining one or more images of crop (e.g. by a camera) and applying a method or system, as disclosed herein, to these images. This method may improve the reliability of measurements under many circumstances, which would seriously increase the quality of the monitoring process.

Spectral imaging in applications of sorting, quality appraisal or monitoring the status of food items may be hampered by minimal spectral differences. This makes it a challenge to obtain accurate and reproducible measurements e.g. over large periods of time and/or at various measurement locations worldwide. The use of reference tiles is of limited value here, as the shape of the surface of the reference tile is very different from the shapes of individual food items. Moreover, In food processing plants serious care would have to be taken to prevent deterioration of any reference tiles used. In addition the quality of the illumination light would have to be monitored constantly. The techniques disclosed herein would enable more accurate spectral imaging without any reference tiles, with reduced or removed burden of monitoring and controlling the illumination used. For example, a method may comprise obtaining one or more images of one or more food items, and applying a method or system, as disclosed herein, to these images.

In some applications of spectral imaging the skin of a person is imaged, either for medical diagnostic purposes such as skin cancer detection, evaluation and monitoring of bruises, monitoring of (neonatal) jaundice, evaluation or monitoring of skin bruises, burn wounds or after plastic surgery or any purpose related to the status of the microvasculature, such as monitoring of skin transplants, lie detection, or screening for fever etc. These applications usually take place in an artificially illuminated environment and the exact position of the subject may be not strongly controlled. Reference measurements are possible, but here too the shape of the reference tile will not be the same as the shape of the imaged subject and this reduces accuracy. Moreover, the spectral properties of the artificial illumination will vary in space and time. The techniques disclosed herein can make these applications more reliable by correcting for spatial and temporal variations in illumination, and by separating the surface reflection from the volume reflection. For example, a method may comprise obtaining one or more images of the skin of a person, e.g. by means of a camera, and applying a method or system, as disclosed herein, to these images.

Spectral imaging for forensic applications, such as the analysis of blood stain patterns, or age estimation of blood stains, are preferably performed rapidly, at short notice, and without disturbing the crime scene. In these applications artificial illumination is often brought in. The techniques disclosed herein would be of great value to this application, as it would help to automatically compensate for any uneven illumination of the crime scene, it may render any reference measurement unnecessary, and it may remove surface reflections from the spectral information, thus enabling simpler measurements of higher accuracy. For example, a method may comprise obtaining one or more images of a blood stain, e.g. by means of a camera, and applying a method or system, as disclosed herein, to these images.

Spectral imaging for assessing the status of artifacts, and art objects, such as costly antique paintings, usually occurs under well-controlled circumstances. Well controlled illumination and reference measurements on tiles with the same flat surface as the painting under investigation. Surface reflection in such a geometry can be removed accurately using crossed polarization filters. Nevertheless the techniques disclosed herein can be of great value here. The techniques disclosed herein are not limited to simply removing the surface reflection, they allow to separate it from the volume reflection and make it explicitly available. The surface reflection intensity, spectrum and distribution may give interesting clues on the quality and state of the painting. The same holds for the volume reflection intensity, spectrum and distribution. For example, a method may comprise obtaining one or more images of an artifact, e.g. by means of a camera, and applying a method or system, as disclosed herein, to these images.

Spectral or RGB imaging for security applications is routinely performed under an extremely broad spectrum of illumination conditions. Applications range from screening for wanted criminals at airports to facial recognition for unlocking personal devices. Facial recognition software routinely uses shape information as well as pixel color values to find matches between images. Like in spectral imaging, the RGB values in regular imaging strongly depend on the spectral quality of the illuminating light. The accuracy of facial recognition for security purposes would strongly benefit from implicit calibration because it would compensate for the different illumination qualities. In addition, the availability of both volume reflection and surface reflection images may enable an additional improvement in the facial recognition accuracy. For example, a method may comprise obtaining one or more images of a face, e.g. by means of a camera, and applying a method or system, as disclosed herein, to these images, to generate an output image. The method may further comprise identifying a person based on the output image.

Spectral imaging of difficult to reach areas have the problem that it is impossible to perform a proper reference measurement at the relevant location. A first example of this is spectral imaging through endoscopes or laparoscopes, for either diagnostic purposes or surgical guidance such as during image guided surgery. The endoscope or laparoscope provides visual access to an area where one cannot place a reference tile. Yet the spectral quality of the illumination light is strongly influenced by the optical quality of the endoscope or laparoscope. An image processing system may comprise an input unit 503 configured to obtain an input image from a camera of an endoscope or laparoscope. For example the system may be integrated in an endoscope or laparoscope, or integrated in a console for such an endoscope or laparoscope. The system may further comprise an output unit 508 configured to output the output image based on a decomposed image intensity of at least one pixel of the input image. The output unit 508 may comprise a display device, for example. The system may further comprise the image processing unit 508 set forth herein.

A second example of difficult areas is spectral imaging for intraoperative imaging, for either diagnostic purposes or surgical guidance such as during image guided surgery. Due to the sterilization requirements one cannot always place a reference tile in the surgical area. Even then, any reference material placed inside the surgical area may quickly be compromised by the presence of body liquids such as blood. For example, a method may comprise obtaining one or more images of an inner portion of a body during surgery, e.g. by means of a camera, and applying the a method or system, as disclosed herein, to these images to generate an output image. The method may further comprise displaying the output image.

Spectral imaging during open surgery, either to find or select the tissue that should be removed, or to assess the possible presence and location of remaining diseased tissue in the surgical margins. In open surgery, resection margins are in principle directly accessible for hyper spectral imaging. Often, however, especially during surgical interventions where only a small lump of tissue is removed and damage to normal tissue is minimized, such as in breast conserving cancer surgery, the margins are difficult to image because they usually have complicated shapes, present under various angles with respect to camera and illumination source and are full of glare. Moreover, the strongly curved surfaces ensure a strong spatial variation in illumination. The techniques disclosed herein could be of great value here, not only, as suggested hereinabove, to avoid the use of a reference tile in a sterile area, but also to remove all complications due to the otherwise uncontrollable problems related to the complicated and variable shape of the imaged surface.

In addition, surface reflection or glare is often seen as classical problem in endoscopy or laparoscopy, as it compromises the visibility in some areas of the image. The techniques disclosed herein may help to solve this problem by enabling the separation of surface reflection and volume reflection.

Spectral or RGB imaging is often performed on samples and compared with microscopic or chemical evaluation of the tissue. This is often done to enable development of classification algorithms. After development of the algorithm in this way, the algorithm can then be applied on a spectrum to perform a rapid diagnosis or classification of the tissue. For instance to train an algorithm for intraoperative diagnosis of breast cancer, or to train an algorithm to sort fruits by ripeness. The datasets obtained for the development of these algorithms are often reduced in accuracy due to an abundance of glare. The techniques disclosed herein may help to separate the diffuse reflection from glare, which may help to increase the accuracy of the algorithms developed. A method may comprise obtaining an image from a camera, applying the techniques disclosed herein thereto (e.g. applying an image processing method or image processing system as set forth, to decompose the image intensity into e.g. volume reflection intensity and surface reflection intensity), and providing an input to an artificial neural network based on the decomposed image intensity. The method may further comprise training the artificial neural network based on the decomposed image intensity.

Some or all aspects of the invention may be suitable for being implemented in form of software, in particular a computer program product. The computer program product may comprise a computer program stored on a non-transitory computer-readable media. Also, the computer program may be represented by a signal, such as an optic signal or an electro-magnetic signal, carried by a transmission medium such as an optic fiber cable or the air. The computer program may partly or entirely have the form of source code, object code, or pseudo code, suitable for being executed by a computer system. For example, the code may be executable by one or more processors.

The examples and embodiments described herein serve to illustrate rather than limit the invention. The person skilled in the art will be able to design alternative embodiments without departing from the spirit and scope of the present disclosure, as defined by the appended claims and their equivalents. Reference signs placed in parentheses in the claims shall not be interpreted to limit the scope of the claims. Items described as separate entities in the claims or the description may be implemented as a single hardware or software item combining the features of the items described.

Certain aspects are disclosed in the following clauses.
1. A computer-implemented image processing method, comprising
dividing (605) a plurality of pixels of an image into a first subset of pixels and a second subset of pixels;
decomposing (606) an image intensity of each pixel in the first subset using a variance of an image intensity of the pixels in a local neighbourhood of each pixel, to obtain at least one image property of each pixel in the first subset;
spatially interpolating (607) said at least one image property to obtain said at least one image property in respect of at least one pixel in the second subset of pixels; decomposing (608) the image intensity of said at least one pixel in the second subset of pixels using the interpolated at least one image property of said at least one pixel in the second subset of pixels.
2. The image processing method according to clause 1, wherein at least one of said decomposing steps (606, 608) comprises decomposing the image intensity into a portion caused by surface reflection with respect to a sample and a portion caused by volume reflection with respect to a sample.
3. The image processing method according to clause 2,
wherein said surface reflection comprises at least one of specular reflection and glare, or
wherein said volume reflection comprises scatter inside the sample.
4. The image processing method according to any preceding clause, wherein the step of dividing (605) the plurality of pixels is performed further based on an image intensity of the pixels.
5. The image processing method according to any preceding clause, wherein the step of dividing (605) the plurality of pixels is performed based on a spatial variance of an image intensity of the pixels.
6. The image processing method according to any preceding clause,
wherein the step of decomposing (606) the image intensity of each pixel in the first subset comprises decomposing that image intensity into at least one component associated with volume reflection, at least one component associated with surface reflection, and at least one further component; and
wherein the image property is associated with the at least one further component.
7. The image processing method according to clause 6,
wherein said at least one component associated with surface reflection comprises a first component associated with a reflection parameter that depends on a wavelength and a second component associated with a coefficient that depends on a spatial location of each pixel.
8. The image processing method according to clause 6 or 7,
wherein said at least one component associated with volume reflection comprises a component that depends on a wavelength.
9. The image processing method according to any one of clauses 6 to 8, wherein the step of decomposing (606) the image intensity of each pixel in the first subset comprises:
solving an equation for each pixel in the first subset for
the image property in respect of the plurality of different wavelength bands,
the component associated with volume reflection in respect of the plurality of wavelengths,
the component associated with the reflection parameter in respect of the plurality of wavelength bands, and
the component associated with the coefficient in respect of a plurality of pixels in the local neighbourhood of each pixel,
based on the image intensities of the plurality of pixels in the local neighbourhood of each pixel in respect of the plurality of different wavelength bands.
10. The image processing method according to any preceding clause,
wherein the step of decomposing (608) the image intensity of said at least one pixel in the second subset of pixels comprises decomposing the image intensity of said at least one pixel in the second subset of pixels into at least one component associated with volume reflection and at least one component associated with surface reflection, using the interpolated at least one image property of said at least one pixel in the second subset of pixels as an input.
11. The image processing method according to clause 10, wherein the step of decomposing (608) the image intensity of said at least one pixel in the second subset of pixels comprises:
solving an equation for:
the component associated with volume reflection in respect of the plurality of wavelength bands,
the component associated with the reflection parameter in respect of the plurality of wavelength bands, and
the component associated with the coefficient in respect of a plurality of pixels in a neighbourhood of said at least one pixel in the second subset of pixels,
based on the image intensities of the plurality of pixels in the neighbourhood of said at least one pixel in the second subset of pixels in respect of the plurality of different wavelength bands and further based on the spatially interpolated image property in respect of said at least one pixel in the second subset of pixels and the plurality of different wavelength bands.
12. The image processing method according to clause 9 or 11, wherein the equations are based on a multiplication of the image property and a combination of the component associated with volume reflection, the component associated with the reflection parameter, and the component associated with the coefficient.
13. The image processing method according to any preceding clause, further comprising generating (609) an output image based on a weighted combination of the decomposed image intensities.
14. The image processing method according to any preceding clause, further comprising receiving the image from a camera.
15. An image processing system comprising
an input unit (503) configured to obtain an input image comprising a plurality of pixels;
an output unit (506) configured to output an output image based on a decomposed image intensity of at least one pixel of the input image; and
an image processing unit (508) configured to:
divide the plurality of pixels of the input image into a first subset of pixels and a second subset of pixels;
decompose an image intensity of each pixel in the first subset using a variance of an image intensity of the pixels in a local neighbourhood of each pixel, to obtain at least one image property of each pixel in the first subset;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.
16. A computer program product comprising instructions configured to cause, when executed by a processor system, the processor system to:
divide a plurality of pixels of an image into a first subset of pixels and a second subset of pixels;
decompose an image intensity of each pixel in the first subset using a variance of an image intensity of the pixels in a local neighbourhood of each pixel, to obtain at least one image property of each pixel in the first subset;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.

1. A computer-implemented image processing method, comprising
dividing a plurality of pixels of an image into a first subset of pixels and a second subset of pixels, based on a spatial variance of an image intensity of the pixels;
decomposing the image intensity of each pixel in the first subset to obtain at least one image property of each pixel in the first subset, wherein the decomposing the image intensity of each pixel in the first subset comprises generating and solving a set of equations for each pixel to be decomposed, using the pixels around each pixel to be decomposed, wherein the equations contain the image property as a variable;
spatially interpolating said at least one image property to obtain said at least one image property in respect of at least one pixel in the second subset of pixels;
decomposing the image intensity of said at least one pixel in the second subset of pixels using the interpolated at least one image property of said at least one pixel in the second subset of pixels.

2. The image processing method according to claim 1, wherein at least one of said decomposing steps comprises decomposing the image intensity into a portion caused by surface reflection with respect to a sample and a portion caused by volume reflection with respect to a sample.

3. The image processing method according to claim 2, wherein said surface reflection comprises at least one of specular reflection and glare, or wherein said volume reflection comprises scatter inside the sample.

4. The image processing method according to claim 1, wherein the step of dividing the plurality of pixels is performed further based on an image intensity of the pixels.

5. The image processing method according to claim 1, wherein the step of decomposing the image intensity of each pixel in the first subset comprises decomposing that image intensity into at least one component associated with volume reflection, at least one component associated with surface reflection, and at least one further component; and wherein the image property is associated with the at least one further component.

6. The image processing method according to claim 5, wherein said at least one component associated with surface reflection comprises a first component associated with a reflection parameter that depends on a wavelength and a second component associated with a coefficient that depends on a spatial location of each pixel.

7. The image processing method according to claim 5, wherein said at least one component associated with volume reflection comprises a component that depends on a wavelength.

8. The image processing method according to claim 5, wherein the step of decomposing the image intensity of each pixel in the first subset comprises:
solving an equation for each pixel in the first subset for
the image property in respect of the plurality of different wavelength bands,
the component associated with volume reflection in respect of the plurality of wavelengths,
the component associated with the reflection parameter in respect of the plurality of wavelength bands, and
the component associated with the coefficient in respect of a plurality of pixels in the local neighbourhood of each pixel,
based on the image intensities of the plurality of pixels in the local neighbourhood of each pixel in respect of the plurality of different wavelength bands.

9. The image processing method according to claim 1, wherein the step of decomposing the image intensity of said at least one pixel in the second subset of pixels comprises decomposing the image intensity of said at least one pixel in the second subset of pixels into at least one component associated with volume reflection and at least one component associated with surface reflection, using the interpolated at least one image property of said at least one pixel in the second subset of pixels as an input.

10. The image processing method according to claim 9, wherein the step of decomposing the image intensity of said at least one pixel in the second subset of pixels comprises:
solving an equation for:
the component associated with volume reflection in respect of the plurality of wavelength bands,
the component associated with the reflection parameter in respect of the plurality of wavelength bands, and
the component associated with the coefficient in respect of a plurality of pixels in a neighbourhood of said at least one pixel in the second subset of pixels,
based on the image intensities of the plurality of pixels in the neighbourhood of said at least one pixel in the second subset of pixels in respect of the plurality of different wavelength bands and further based on the spatially interpolated image property in respect of said at least one pixel in the second subset of pixels and the plurality of different wavelength bands.

11. The image processing method according to claim 8, wherein the equations are based on a multiplication of the image property and a combination of the component associated with volume reflection, the component associated with the reflection parameter, and the component associated with the coefficient.

12. The image processing method according to claim 1, further comprising generating an output image based on a weighted combination of the decomposed image intensities.

13. The image processing method according to claim 1, further comprising receiving the image from a camera.

14. An image processing system comprising
an input unit configured to obtain an input image comprising a plurality of pixels;
an output unit configured to output an output image based on a decomposed image intensity of at least one pixel of the input image; and
an image processing unit configured to:
divide the plurality of pixels of the input image into a first subset of pixels and a second subset of pixels, based on a spatial variance of an image intensity of the pixels;
decompose the image intensity of each pixel in the first subset to obtain at least one image property of each pixel in the first subset, wherein the image processing unit is configured to generate and solve a set of equations for each pixel to be decomposed, using the pixels around each pixel to be decomposed, wherein the equations contain the image property as a variable;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.

15. A computer program product comprising instructions configured to cause, when executed by a processor system, the processor system to:
divide a plurality of pixels of an image into a first subset of pixels and a second subset of pixels, based on a spatial variance of an image intensity of the pixels;
decompose the image intensity of each pixel in the first subset to obtain at least one image property of each pixel in the first subset, wherein the decomposing the image intensity of each pixel in the first subset comprises generating and solving a set of equations for each pixel to be decomposed, using the pixels around each pixel to be decomposed, wherein the equations contain the image property as a variable;
spatially interpolate said at least one image property to obtain said at least one image property of at least one pixel in the second subset of pixels; and
decompose the image intensity of said at least one pixel in the second subset of pixels using the interpolated at least one image property of said at least one pixel in the second subset of pixels.
